(19) United States
(12) Patent Application Publication
(10) Pub. No.: US 2016/0121303 A1
(43) Pub. Date: May 5, 2016

(54) PROCESSES FOR THE PREPARATION OF MESOPOROUS METAL OXIDES

(71) Applicant: UNIVERSITY OF CONNECTICUT, Farmington, CT (US)

(72) Inventors: Steven L. SUIB, Storrs, CT (US); Altug Suleyman POYRAZ, Willington, CT (US)

(21) Appl. No.: 14/932,137

(22) Filed: Nov. 4, 2015

Related U.S. Application Data
(60) Provisional application No. 62/074,718, filed on Nov. 4, 2014.

(51) Int. Cl. B01J 23/34; B01J 35/10; B01J 35/02; C01G 45/02; B01J 37/08

(52) U.S. Cl. CPC B01J 23/34; C01G 45/02; B01J 37/08; B01J 35/023; B01J 35/1019; B01J 35/1038; B01J 35/1085; B01J 35/1061; C01P 2004/64; C01P 2004/62; C01P 2006/12; C01P 2006/14; C01P 2006/17

(57) ABSTRACT

A process for preparing a crystalline mesoporous metal oxide, i.e., crystalline mesoporous transition metal oxide, crystalline mesoporous Lanthanide metal oxide, a crystalline mesoporous post-transition metal oxide and crystalline mesoporous metalloid oxide. The process comprises providing an acidic mixture comprising an amorphous mesoporous metal oxide; and heating the acidic mixture at a temperature and for a period of time sufficient to form the crystalline mesoporous metal oxide. A crystalline mesoporous metal oxide prepared by the above process. A method of controlling nano-sized wall crystallinity and mesoporosity in crystalline mesoporous metal oxides. The method comprises providing an acidic mixture comprising an amorphous mesoporous metal oxide; and heating the acidic mixture at a temperature and for a period of time sufficient to control nano-sized wall crystallinity and mesoporosity in the mesoporous metal oxides. Crystalline mesoporous metal oxides and a method of tuning structural properties of mesoporous metal oxides.

### RELATED APPLICATIONS

This application claims the benefit of U.S. Provisional Application Ser. No. 62/074,718, filed on Nov. 4, 2014, which is incorporated herein by reference in its entirety. This application is related to U.S. patent application Ser. No. 14/037,100, filed Sep. 25, 2013; U.S. patent application Ser. No. 14/037,107, filed Sep. 25, 2013; U.S. Patent Application Serial No. PCT/US14/37285, filed May 8, 2014; and U.S. Patent Application Serial No. PCT/US14/37292, filed May 8, 2014, all of which are incorporated herein by reference in their entirety.

### BACKGROUND

1. Field of the Disclosure

This disclosure relates to processes for making crystalline mesoporous metal oxides under mild process conditions, in particular, the synthesis of crystalline mesoporous metal oxides with controllable nano-sized wall crystallinity and mesoporosity. This disclosure also relates to a method of tuning structural properties of mesoporous metal oxides, and a method of controlling nano-sized wall crystallinity and mesoporosity in mesoporous metal oxides.

2. Discussion of the Background Art

Porous transition metal oxides consist of micropores (<2 nm), mesopores (2-50 nm), macropores (>50 nm) and sometimes combinations of these. Considerable interest in the control of pore sizes and pore size distributions of such materials has been a focus for quite some time. The control of particle size in particular in the nanometer regime in the synthesis of nano-size metal oxides is also currently being pursued. Nano-size materials can have markedly different properties than similar compositions that are bulk size (μm and above). Control of morphologies of porous transition metal oxides such as hollow spheres, rods, helices, spirals, and many other shapes has been a major focus of researchers over at least the last 10 years.

Such control comes from specific synthetic methods such as use of templates, structure directors, surfactants, core shell, self assembly, epitaxial growth, size reduction, capping agents, sol gel, and other methods. Morphologies can be controlled by compositions including dopants. The conditions during syntheses such as use of heat, light, pH, point of zero charge, stirring, high pressure, and others are also important.

Mesoporous materials with varied pore sizes and pore size distributions can be obtained for some systems such as silicon and titanium based oxide materials. However, control of pore size distributions to make single size pores and to systematically control such pore sizes and uniformity is difficult, especially with transition metal oxide systems. Control of the structure of the material is also an issue. Many systems have both micropores and mesopores and pore interconnectivity is of interest with these materials. Enhanced mass transport for catalytic reactions might be realized by fine-tuning the porosity of such systems. Incorporation of biomolecules larger than the micropore regime also might be done using well ordered crystalline mesoporous materials.

Most studies of mesoporous transition metal oxide (MTMO) materials have focused on groups I-IV including Y, Ti, Hf, Zr, V, Nb, Ta, Cr, Mo, and W. These have low angle X-ray diffraction peaks indicative of mesostructural ordering and Type IV isotherms. These syntheses have focused on use of water or water plus a base or urea with various amine and carboxyl containing surfactants (S). There are either strong Coulombic interactions (S⁺,I⁻; S⁻I⁺; S⁺X⁻I⁺; S⁻X⁺I⁻) or strong ligand metal interactions (I:S<2, very thin walls), and such systems have limited thermal stability and amorphous walls, where I=inorganic species, and X is a mediator. Such syntheses are open to air and various aging times and environmental conditions can influence the porosity of these materials.

Water content is a critical parameter with the synthesis of porous transition metal oxides. Water competes with ethoxy and other alkoxy groups for coordination to the metal and also significantly affects hydrolysis and condensation rates. Since most syntheses are open to the air the water content is very difficult to control. On the other hand, water is essential for reaction. When the number of water molecules per metal atom (H) is >1 then phase separation and nonporous oxides result. When H is <1, ordered mesoporous materials are formed when the metal has empty t_{2g} orbitals. These materials obtain water from the environment during synthesis. When H is <<1, strong surfactant/transition metal interactions occur with weak surfactant surfactant interactions and there is no reaction.

Thermodynamic interactions in such syntheses and factors influencing each term are given in Table 1 below. Table 1 sets forth thermodynamic parameters of surfactant (S) transition metal (M) mesopore syntheses.

ΔGₘ = ΔG_{org} + ΔG_{I} + ΔGᵢₙₜₑᵣ + ΔGₛₒₗ [1]

| | | | |
|---|---|---|---|
| S-S Interaction | High Lewis | Strong S-M | Unknown and |
| determines | acidity | interaction at | unpredictable |
| mesostructure | Unsaturated | interface | |
| formed | Coordination | (Coulombic, | |
| (Lamellar, | H (Hydrolysis | Covalent | |
| Hexagonal, | Ratio H<<1), | bonding, | |
| Cubic) | Condensation | Hydrogen | |
| | hindering | bonding) | |
| | molecules | | |
| | (carboxyl, amine, | | |
| | ethylene glycol.) | | |

In Equation 1 above, ΔGₘ is the formation energy of the mesostructured material; ΔG_{org} is the surfactant-surfactant interaction; ΔG_{I} is the metal-metal interaction; ΔGᵢₙₜₑᵣ is the surfactant-metal interaction; and ΔGₛₒₗ is the solvent interaction. It would be desirable to develop a process that minimizes the last 2 terms, ΔGᵢₙₜₑᵣ and ΔGₛₒₗ, in order to make well ordered MTMO materials. The absence of totally empty d orbitals restricts the strong interaction between surfactant and metal (ligand to metal charge transfer) which is generally accepted as essential for the formation of ordered materials. Filled t_{2g} orbitals such as in systems containing Mn, Fe, Co, and other oxides make syntheses using the above methods difficult since charge transfer reactions do not occur.

The present disclosure provides many advantages over the prior art, which shall become apparent as described below.

### SUMMARY OF THE DISCLOSURE

This disclosure relates in part to a process for preparing a crystalline mesoporous metal oxide. The process comprises:

providing an acidic mixture comprising an amorphous mesoporous metal oxide; and

heating the acidic mixture at a temperature and for a period of time sufficient to form the crystalline mesoporous metal oxide.

This disclosure also relates in part to a crystalline mesoporous metal oxide produced by a process comprising:

providing an acidic mixture comprising an amorphous mesoporous metal oxide; and

heating the acidic mixture at a temperature and for a period of time sufficient to form the crystalline mesoporous metal oxide.

This disclosure further relates in part to a method of controlling nano-sized wall crystallinity and mesoporosity in mesoporous metal oxides. The method comprises:

providing an acidic mixture comprising an amorphous mesoporous metal oxide; and

heating the acidic mixture at a temperature and for a period of time sufficient to control nano-sized wall crystallinity and mesoporosity in the mesoporous metal oxides.

This disclosure yet further relates in part to a crystalline mesoporous metal oxide particulate having nano-sized wall crystallinity, a particle size between about 1 and about 500 nm, a BET surface area between about 50 and about 1000 m²/g, a pore volume (BJH) between about 0.05 and about 2 cm³/g, a monomodal pore size (BJH desorption) distribution between about 1 and 25 nm, and optionally a wall thickness (2 d/√3−PD, where d is the d-spacing and PD is the pore diameter) between about 2 and about 20 nm; wherein the mesoporous metal oxide particulate exhibits thermal stability up to a temperature of about 550° C.

This disclosure also relates in part to a method of tuning structural properties of mesoporous metal oxides. The method comprises:

providing an acidic mixture comprising an amorphous mesoporous metal oxide; and

heating the acidic mixture at a temperature and for a period of time sufficient to tune the structural properties of the mesoporous metal oxides.

Several advantages result from the processes of this disclosure. This disclosure provides a process that can be conducted at much milder conditions than conventional syntheses approaches for tunnel structured manganese oxides. For example, the process of this disclosure can be conducted under aqueous acidic solutions less than or equal to 0.5 M H⁺ or less than or equal to 0.5 M K⁺, at low temperatures (less than or equal to 80° C.), and short times (less than or equal to 2 hours. Typically, for conventional processes, high temperatures greater than 120° C. and pressures greater than 2 bar are involved. Therefore, the process of this disclosure provides a more economical approach with enhanced electronic and redox properties for the same crystal structures.

This disclosure provides a unique approach and method for the synthesis of thermally stable crystalline mesoporous metal (e.g., Mn, Fe, Co, Ni, Cu, Zn, Ti, Zr, Si, Ce, Sm and Gd) oxides under mild conditions with controllable mesopore size (e.g., 2 nm-13 nm) and nano-sized crystalline walls for various sorptive, conductive, structural, catalytic, magnetic and optical applications. This disclosure not only makes the synthesis of crystalline mesoporous (metal, transition metal, Lanthanide metal, post-transition metal, metalloid) oxides possible, but also allows one to precisely tune the structural properties of synthesized porous materials under mild process conditions. Moreover, the method of this disclosure is applicable to all transition metals, Lanthanide metals, post-transition metals and metalloids with modifications as appropriate in the synthesis procedure.

Further objects, features and advantages of the present disclosure will be understood by reference to the following drawings and detailed description.

### BRIEF DESCRIPTION OF THE DRAWINGS

FIG. 1 depicts a schematic illustration of the general synthetic approach to form crystalline mesoporous manganese oxides in accordance with Examples 1-5.

FIG. 2 depicts (a) low-angle PXRD, (b) wide-angle PXRD, (c) N₂ sorption isotherms, and (d) BJH desorption pore size distributions of mesoporous manganese oxides: Meso-Mn-A, Meso-Mn₂O₃, Meso-Mn₃O₄, Meso-ε-MnO₂, and Meso-OMS-2 of Examples 1-5.

FIG. 3 depicts a table of the physicochemical properties of mesoporous and non-porous manganese oxide samples of Examples 1-5.

FIG. 4 depicts (a) N₂ sorption isotherms, (b) low-angle PXRD, and (c) wide-angle PXRD patterns of CMn₂O₃, C—Mn₃O₄, and R-OMS-2 samples of Examples 1-5.

FIG. 5 depicts PXRD patterns of commercial Mn₂O₃ (C—Mn₂O₃) and acid treated commercial Mn₂O₃ (CMn₂O₃-Acid). C—Mn₂O₃ was kept in 0.5 M H₂SO₄ for 4 hours @ 80° C. The black box was enlarged in the inset.

FIG. 6 depicts SEM images of mesoporous manganese oxides (a) Meso-Mn₂O₃, (b) Meso-ε-MnO₂, and (c) Meso-OMS-2.

FIG. 7 depicts HR-TEM images of mesoporous manganese oxides (a) Meso-Mn-A, (b) Meso-ε-MnO₂, and (c) Meso-OMS-2.

FIG. 8 depicts H₂-TPR (temperature-programming reduction) profiles of mesoporous manganese oxides (Meso-Mn-A, Meso-Mn₂O₃, Meso-ε-MnO₂, and Meso-OMS-2), C—Mn₂O₃, and R-OMS-2 samples.

FIG. 9 depicts a table of catalytic performances of mesoporous manganese oxides that were tested for selective oxidation of benzyl alcohol (to benzaldehyde).

FIG. 10 depicts the catalytic performance of mesoporous manganese oxides, C—Mn₂O₃, and RefluxOMS-2 samples at 2% O₂, (b) catalytic stability test at different O₂ amounts with Meso-ε-MnO₂ sample.

### DETAILED DESCRIPTION OF THE PREFERRED EMBODIMENT

All numerical values within the detailed description and the claims herein are modified by “about” or “approximately” the indicated value, and take into account experimental error and variations that would be expected by a person having ordinary skill in the art.

Nanostructured and mesoporous multivalent transition metal oxides have limited use due to synthetic limitations. Only certain (generally one) crystal phases can be obtained by conventional approaches. However, their versatile use arises from their numerous oxide structures formed by multiple oxidation states of these transition metal oxides (i.e., Mn, Fe, Co). The process of this disclosure provides a mild transformation of mesoporous manganese oxide to other numerous crystal structures of manganese oxides by preserving mesoporosity. Therefore, one can obtain a desired crystal structure of manganese oxide with high surface area, tunable mesopore size and volume, and controllable nanocrystallinity. The same or similar approaches can be applicable to other multivalent transition metal oxides as described herein.

In particular, this disclosure provides new manganese oxide base mesoporous materials. Mesoporous multivalent transition metal oxides, such as manganese, are superior to those of their non-porous counterparts in catalytic, electronic, sorption, and magnetic properties. However, due to synthetic limitations in sol-gel chemistry of manganese, the mesoporous manganese oxides can only be synthesized with a limited number of crystal phases (Mn₂O₃ or Mn₃O₄). In addition to thermodynamically stable major Mn₂O₃ (Bixybyite, Mn=3⁺), Mn₃O₄ (Hausmannite, Mn=2⁺ & 3⁺), and β-MnO₂ (Mn=4⁺) phases, there are also many other oxide structures (i.e., Mn₅O₈, and MnO), polymorphs of MnO₂ (α-, β-, γ-, δ-, ε-, and λ-) and cation stabilized octahedral coordinated microporous manganese oxides (octahedral molecular sieves, OMS). In an embodiment, this disclosure provides a novel transformation method for obtaining other crystal structures of manganese oxide by preserving mesoporosity and nanocrystallinity.

Manganese oxides are one of the most abundant and cheap transition metal oxides. Moreover, it's more than 5 (+2, +3, +4, +5, and +7) thermodynamically stable oxidations states allow one to obtain numerous polymorphs and crystal structures. Therefore, it is widely used in catalysis, semiconductor, electronic, and magnetic devices industries. The synthesized high surface area mesoporous manganese oxides can potentially be very useful in these industries.

In an embodiment, the method of this disclosure allows one to convert mesoporous manganese oxides to numerous tunnel structured manganese oxides with manganese being in +2, +3, and +4 oxidation states. These materials are formed by the same manganese octahedral building block (MnO₆) and the tunnels sizes are controlled by charge balancing cations. The typical cations are K⁺, Ag⁺, H⁺, Rb⁺, Ba²⁺, Cr³⁺, Na⁺, Rb⁺, Na⁺, Li⁺, CTA⁺, Mg²⁺, etc. The materials' redox, magnetic, acid-base, sorption, capacitance, and electronic properties can be further tuned by using doants (i.e. Cr³⁺, Fe³⁺, V⁵⁺, Co²⁺, Zr²⁺, Cu²⁺, IN³⁺, W⁶⁺, and Mo⁶⁺).

In an embodiment, the method can potentially create at least 560 (10 (cations)×9 (single doping)×8 (multi doping)×6=560) different modifications of mesoporous manganese oxides. The situation can be further expanded when 6 different tunnels possibilities are included (560×6=3360).

The syntheses conditions of this disclosure are much milder (aqueous acidic solutions less than or equal to 0.5 M H+ or less than or equal to 0.5 M K+), at low temperatures (less than or equal to 80° C.), and short times (less than or equal to 2 hours) than conventional synthesis approaches for tunnel structured manganese oxides. Typically, high temperatures (greater than 120° C.) and pressures (greater than 2 bar) are involved. Therefore, the process of this disclosure provides a more economical approach with enhanced electronic and redox properties for the same crystal structures.

The crystalline mesoporous metal oxides of this disclosure have high surface area, tunable mesoporosity and maintain nanocrystallinity. The porous structures of the crystalline mesoporous metal oxides (e.g., manganese oxide) phases are unique. The process of this disclosure is applicable to other multivalent transition metal oxides to obtain mesoporous transition metal oxides with various crystal structures as described herein. The process conditions are significantly milder than the direct conventional synthesis of the target structure. The process of this disclosure is generic and small modifications in the synthesis conditions are enough to obtain different phases of metal (e.g., manganese) oxides.

Synthesis of microporous cation stabilized octahedral molecular sieves (OMS) and polymorphs of MnO₂ structure generally requires high temperatures (as high as 180° C.), pressures (as high as 10 bar), and strong oxidants (i.e. KMnO₄, Na₂S₂O₈). However, the syntheses reported in the invention disclosure are much milder (aqueous acidic solutions (less than or equal to 0.5 M H⁺ or less than or equal to 0.5 M K⁺), at low temperatures (less than or equal to 80° C.), and short times (less than or equal to 2 hours) than conventional synthesis approaches for tunnel structured manganese oxides. The reported approach allows one to synthesize these phases at lower temperatures, shorter time, and reduces cost of the materials. In addition, the materials are mesoporous and have high surface areas compared to the materials synthesized by conventional methods.

The process of the present disclosure for making mesoporous metal oxides affords a high degree of control with respect to nano-sized wall crystallinity and mesoporosity. The mesoporous metal oxides are useful in various applications including, but not limited to, catalytic, magnetic and optical applications. In particular, the mesoporous metal oxides are useful as catalysts, sensors, batteries and energy production, optical displays, environmental and sorbent applications.

This disclosure offers a new type of porous metal oxide family. The disclosure not only makes use of a wide range of metals, e.g., transition metals, Lanthanide metals, post-transition metals and metalloids, but also provides more control on the structural properties of synthesized mesoporous metal oxides.

The method of this disclosure eliminates contribution of critical thermodynamic parameters such as strength of interaction at interface, hydrolysis and condensation rates of metal oxides and water content of reaction medium, thereby yielding totally reproducible porous metal oxides. For example, solvation by water is eliminated or minimized by eliminating or minimizing the amount of water in the system. This in turn limits hydrolysis.

The present disclosure provides a simple wet-chemical process that enables the synthesis of nanometer-sized particles (50-300 nm) with tunable pore sizes in the range of 2-30 nm, preferably 2-20 nm, and more preferably 2-13 nm. This synthesis may be generalized to achieve various pore structures, including 3-D cubic Im-3 m, 3-D cubic Fm-3 m, 2-D hexagonal p6m, foam-like and worm-like pores, as well as different material compositions. The synthesis can produce ultrafine particles with well-defined mesopores, regular particle morphology and excellent pore accessibility. The mesopores are adjustable in size and have high structural ordering.

One of the unique features of the porous materials synthesized with this method is the tunable porosity. The pore diameter can be controlled between super micropore range (e.g., about 2 nm) and mid-mesopore range (e.g., about 13 nm) without losing available pore volume. Tunable pore size might be useful for various catalytic applications in terms of size selective reactions and enhanced ion mobility for battery applications, etc.

Another unique advantage of this method is controlling the crystal structure of the nano-sized metal oxide walls. For instance, amorphous, bixbyite, hausmannite and manganite structures can be obtained for the manganese system. That makes possible the synthesis of target crystal structure for specific applications. Different crystal structures of metals show different optic, magnetic and catalytic properties which indicate that the method described herein is highly desirable for designing unique porous materials.

Other illustrative crystal structures of the nano-sized metal oxide walls include, for example, CeO₂, Mn₂O₃, Mn₃O₄, Fe₂O₃, Co₃O₄, ZnO, CuO, TiO₂ (Anatase), ZrO₂, NiOOH, and the like. The method of this disclosure provides for controllable nano-sized wall crystallinity and the synthesis of target crystal structures for specific applications.

In accordance with this disclosure, well ordered crystalline mesoporous metal oxide systems can be prepared that can result in enhanced sorptive, conductive, structural, catalytic, magnetic and optical properties, in particular, enhanced catalytic activity and selectivity from better transport properties.

In accordance with this disclosure, using mild reaction conditions, the d-spacings increase. The unit cell expands during heat treatment. The exact position of the d(100) peak depends on the heating temperature and time. Corresponding BET surface area (100-200 m²/g), pore size distributions, and pore volumes (up to 0.22 cc/g) show that mesporous materials are produced with excellent control of pore size distributions (monomodal). These materials are stable up to 550° C. Such control of pore size distribution, enhanced pore volumes, and thermal stabilities are significant advantages afforded with metal oxide mesoporous compositions prepared in accordance with the process of this disclosure.

In the process of this disclosure, the acidic mixture may comprise water, and may be an aqueous mixture. The mixture may be a solution, a dispersion or an emulsion, a micellar solution, and may be a microemulsion. The mixture may have a pH between about 0.5 and about 5, or between about 1 and about 3.

The amorphous mesoporous metal oxides useful in the process of this disclosure include amorphous mesoporous metal oxides of transition metals, Lanthanide metals, post-transition metals, metalloids, and mixtures thereof. For example, the amorphous mesoporous transition metal oxides comprise amorphous mesoporous Group 3-12 transition metal oxides, in particular, Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and Hg oxides. In an embodiment, the amorphous mesoporous transition metal oxides are selected from amorphous mesoporous Group 6-12 transition metal oxides including Cr, Mo, W, Mn, Tc, Re, Fe, Ru, Os, Co, Rh, Ir, Ni, Pd, Pt, Cu, Ag, Au, Zn, Cd and Hg oxides. Preferably, the amorphous mesoporous Group 6-12 transition metal oxides include Mn, Fe, Co, Ni, Cu and Zn oxides. The amorphous mesoporous Lanthanide metal oxides include La, Ce, Pr, Nd, Pm, Sm, Eu, Gd, Tb, Dy, Ho, Er, Tm, Yb and Lu oxides, or any mixture thereof. The amorphous mesoporous post-transition metal oxides include Al, Ga, In, Tl, Sn, Pb and Bi oxides, or any mixture thereof. The amorphous mesoporous metalloid oxides include B, Si, Ge, As, Sb, Te, Po and At oxides, or any mixture thereof.

The concentration of the amorphous mesoporous metal oxides used in the process of this disclosure can vary over a wide range and need only be at a concentration sufficient to form the crystalline mesoporous metal oxides. The amorphous mesoporous metal oxides can be present in a molar concentration ratio of from about 1×10⁻² M to about 10 M, preferably from about 1×10⁻¹ M to about 5M, and more preferably from about 5×10⁻¹ M to about 1 M (based on a total volume of 10 milliliters).

One or more acids may be used in the process of this disclosure to prepare the acidic mixture. As described herein, the acidic mixture may have a pH between about 0.5 and about 5, or between about 1 and about 3. The pH of the mixture can be adjusted by the addition of an acid. Illustrative acids useful in the process of this disclosure include, for example, HNO₃. If the hydrotropic ion High pH systems can be used with metals that show high solubility at low and high pH values.

The concentration of the acid used in the process of this disclosure can vary over a wide range and need only be at a concentration sufficient to impart to the mixture a pH between about 0.5 and about 5, or between about 1 and about 3.

The replacement of nitrate ions with a material that can gradually decrease the pH under process conditions may be useful in the process of this disclosure. Atmospheres of urea vapor or ammonia or other volatile bases may be useful in accomplishing the above. Hydrocyanation may be used, or HF or other acids. The concepts of the use of an acid or a base and controlling pH are embodiments of this disclosure.

The step of preparing the acidic mixture may comprise combining the amorphous mesoporous metal oxide with an acidic source. The mixture may be a solution, a micellar solution, a microemulsion, an emulsion, a dispersion or some other type of mixture. Before, during and/or after the combining, the acidic mixture may be agitated, e.g. shaken, stirred, swirled, sonicated or otherwise agitated. The mixture may have a pH between about 0.5 and about 5, or between about 1 and about 3.

The process may comprise the step of agitating the acidic mixture to form a solution, a dispersion or an emulsion. The emulsion may be a microemulsion. The agitating may be vigorous, moderate or mild. It may comprise shaking, stirring, sonicating, ultrasonicating, swirling or some other form of agitation. The step of reacting may comprise the step of agitating the acidic mixture or the step of agitating the acidic mixture may be a separate step conducted before the step of reacting.

In accordance with the process of this disclosure, the acidic mixture is heated at a temperature and for a period of time sufficient to form the crystalline mesoporous metal oxide. The heating may be in air, or in some other gas, for example, oxygen, nitrogen, carbon dioxide, helium, argon or a mixture of any two or more of these.

The acidic mixture is heated in the following manner. The acidic mixture can be heated at a temperature less than about 80° C., preferably less than about 70° C., and more preferably less than about 60° C., for a period less than about 2 hours, preferably less than about 1.5 hours, and more preferably less than about 1 hour.

The process of this disclosure can be conducted at a pressure sufficient to form the crystalline mesoporous metal oxide materials. Positive or negative pressures may be useful in the process of this disclosure. Suitable combinations of pressure, temperature and contact time may be employed in the process of this disclosure, in particular, temperature-pressure relationships that give crystalline mesoporous metal oxide materials having desired properties and/or characteristics. Normally the process is carried out at ambient pressure.

In an embodiment, the crystalline mesoporous metal oxides can be nanoparticulates having a particle size between about 1 and about 500 nm, or between about 50 and about 300 nm, and a mean pore size between about 1 and about 50 nm, or between about 1 and about 30 nm or greater than 2 nm, or between about 2 and 13 nm. The nanoparticulates may have a 3-D cubic or 3-D foam-like mesostructure, or may have a 2-D hexagonal or wormlike mesostructure. The mesoporous nanoparticulates may comprise mesoporous transition metal oxides, Lanthanide metal oxides, post-transition metal oxides and metalloid oxides. The mesoporous metal oxides may be doped with other elements, for example titanium, aluminum or zirconium. The mesoporous nanoparticulates may be spherical or some other regular shape. There is also provided a plurality of mesoporous nanoparticulates. The mean particle size of the nanoparticulates may be between about 1 and about 500 nm. The particle size distribution may be broad or narrow. There may be less than about 50% of nanoparticulates having a particle size more than 10% different from (greater than or less than) the mean particle size.

The crystalline mesoporous metal oxides prepared by the process of this disclosure include oxides of transition metals, Lanthanide metals, post-transition metals, metalloids, and mixtures thereof. For example, the transition metal oxides comprise Group 3-12 transition metal oxides, in particular, Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and Hg oxides. In an embodiment, the transition metal oxides are selected from Group 6-12 transition metal oxides including Cr, Mo, W, Mn, Tc, Re, Fe, Ru, Os, Co, Rh, Ir, Ni, Pd, Pt, Cu, Ag, Au, Zn, Cd and Hg oxides. Preferably, the Group 6-12 transition metal oxides include Mn, Fe, Co, Ni, Cu and Zn oxides. The Lanthanide metal oxides include La, Ce, Pr, Nd, Pm, Sm, Eu, Gd, Tb, Dy, Ho, Er, Tm, Yb and Lu oxides, or any mixture thereof. The post-transition metal oxides include Al, Ga, In, Tl, Sn, Pb and Bi oxides, or any mixture thereof. The metalloid oxides include B, Si, Ge, As, Sb, Te, Po and At oxides, or any mixture thereof.

The surface area of the mesoporous metal oxide particulates, e.g. BET surface area, maybe between about 50 and about 1000 m²/g, and may be between about 60 and 500, 70 and 200 and 80 and 190, m²/g, and may be about 50, 75, 100, 125, 150, 175 or 200 m²/g.

The pore volume (BJH) may be between about 0.05 and about 2 cm³/g, or between about 0.075 and 2, and 0.1 and 2 cm³/g, and may be about 0.05, 0.1, 0.15, 0.2 or 0.25 cm³/g.

The pore size (diameter), e.g., BJH desorption, may be between about 1 and 50 nm, or between about 1.5 and 50 nm, 1.5 and 20 nm, 2 and 15 nm, and 2 and 13 nm, and may be about 2.0, 2.5, 3.0, 3.5, 4.0, 4.5, 0.5.0, 5.5 and 6 nm.

The wall thickness (2 d/√3−PD, where d is the d-spacing and PD is the pore diameter) may be between about 2 and about 20 nm, or between about 3 and about 16 nm, 4 and 14 nm, or 5 and 12 nm, and may be about 5.0 5.5, 6.0, 6.5, 7.0, 7.5, 8.0, 8.5, 9.0, 9.5 and 10.0 nm. The formula applies to 2-dimensional hexagonal materials.

The crystal structures of the nano-sized metal oxide walls include, for example, CeO₂, Mn₂O₃, Mn₃O₄, Fe₂O₃, Co₃O₄, ZnO, CuO, TiO₂ (Anatase), ZrO₂, NiOOH, and the like.

The mesoporous particulates may be round or spherical, or may be oblate spherical, rod-like, aggregated, ellipsoid, ovoid, a modified oval shape, dome shaped, hemispherical; a round ended cylinder, capsule shaped, discoid, prismatic, acicular or polyhedral (either regular or irregular) such as a cube, a rectangular prism, a rectangular parallelepiped, a triangular prism, a hexagonal prism, rhomboid or a polyhedron with between 4 and 60 or more faces, or may be some other shape, for example an irregular shape.

The mesoporous metal oxides of this disclosure exhibit properties that are advantageous for specific applications. For example, the mesoporous metal oxides can exhibit thermal stability up to a temperature of about 350° C., preferably up to a temperature of about 450° C., and more preferably up to a temperature of about 550° C. Also, the mesoporous metal oxides can exhibit high pore volume after heat treatment cycles. For example, the unit cell expansion and pore-size increase do not cause a significant change at pore volume. In other words, ideally for a given material, one can change the pore size from the super micropore region (about 2 nm) to the mid mesopore region (about 20 nm) by preserving pore volume. Further, the mesoporous metal oxides can exhibit physicochemical properties after catalytic reactions under high pressure and temperature. For example, catalytic tests done on mesoporous ZrO₂ and CeO₂ under 20 bar pressure of N₂ or H₂ at 150° C. did not cause any change of physicochemical properties of the materials.

The mesoporous metal oxide nanoparticulates, or a plurality thereof, can be useful for a variety of applications including, for example, catalysis, gas adsorption, synthesis of quantum dots and magnetic nanoparticles in functional materials and bioimaging applications, and as carriers for drugs, genes and proteins for biomedical applications. In particular, the mesoporous metal oxides are useful as catalysts, sensors, batteries and energy production, optical displays, environmental and sorbent applications.

There are several advantages afforded by the method of this disclosure including, for example, control of the crystal structure of the wall during heating, precise control of pore size, and the method can be extended to a variety of transition metal oxides, Lanthanide oxides, post-transition metal oxides and metalloid oxides. Other advantages of the process of this disclosure for the synthesis of mesoporous metal oxides are that H⁺ is not a concern, in principle the process is applicable to all transition metals, Lanthanide metals, port-transition metals and metalloids, gelation is not required, the crystal structure (i.e., for manganese oxides, Hausmannite, Pyrolusite, Bixbyite) can all be formed, thickness of walls can be controlled, fine tuning of magnetic and optical properties is possible, and pore expansion on heat treatment of the mesoporous materials occurs. Highly optically pure glass materials, light sensitive lenses and ultra violet absorbing lenses for plastic or glass materials may be made in accordance with the process of this disclosure.

In the above detailed description, the specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the disclosure is not limited to the specific embodiments described above, but rather, the disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

All reactions in the following examples were performed using as-received starting materials without any purification.

### Example 1

### General Procedure for Synthesis of Mesoporous Transition Metal Oxides

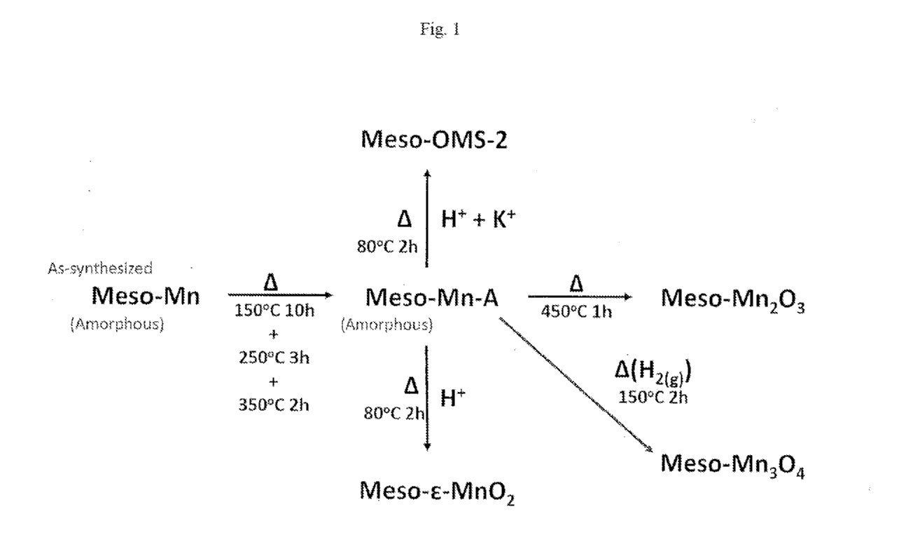

FIG. 1 depicts a reaction scheme that summarizes the general synthetic approach for the synthesis of mesoporous crystalline manganese oxides with various different crystal structures. As synthesized mesoporous amorphous manganese oxide (Meso-Mn) was subjected to a heating cycle of 150° C. for 10 hours+250° C. for 3 hours+350° C. for 2 hours to obtain mesoporous a Meso-Mn-A sample. This sample was used as the parent sample for the synthesis of other crystalline manganese oxide materials.

### Example 2

### Synthesis of Mesoporous Mn₃O₄ (Meso-Mn₃O₄, UCT-60)

0.1 grams of Meso-Mn-A sample was packed in a quartz tube (9 mm diameter) with the help of quartz wool and the packed tube was placed in a tubular furnace. The furnace was heated to 150° C. (5° C./min) and kept at that temperature for 2 hours under 5% H₂ flow (diluted in N₂) with a flow rate of 50 cc/min. After 2 hours, the sample was cooled to room temperature (RT) under ambient conditions.

### Example 3

### Synthesis of Mesoporous Mn₂O₃ (Meso-Mn₂O₃, UCT-2)

0.1 g of Meso-Mn-A sample was heated at 450° C. for 1 hour under ambient conditions to synthesize Meso-Mn₂O₃.

### Example 4

### Synthesis of Mesoporous ε-MnO₂ (Meso-ε-MnO₂, UCT-59)

Amorphous Meso-Mn-A sample (0.3 grams) was dispersed in 50 milliliters of 0.5M H₂SO₄ aqueous solution (DDI water) and sonicated at RT for 10 minutes. The formed homogeneous suspension was transferred to a glass autoclave and the autoclave was placed in an oven running at 70° C. for 2 hours. The obtained powder was filtered and washed several timed with DDI water and finally dried in a vacuum oven over night. The sample was labeled as Meso-ε-MnO₂.

### Example 5

### Synthesis of Mesoporous K₂₋ₓMn₈O₁₆ (Cryptomelane) (OMS-2)

Amorphous Meso-Mn-A sample (0.3 grams) was dispersed in a 50 milliliter aqueous solution (DDI water) containing 0.5 M H₂SO₄+0.5 M KCl and sonicated at RT for 10 minutes. The formed homogeneous suspension was transferred to a glass autoclave and the autoclave was placed in an oven running at 70° C. for 2 hours. The obtained powder was filtered and washed several timed with DDI water and finally dried in a vacuum oven over night. The sample was labelled as Meso-OMS-2.

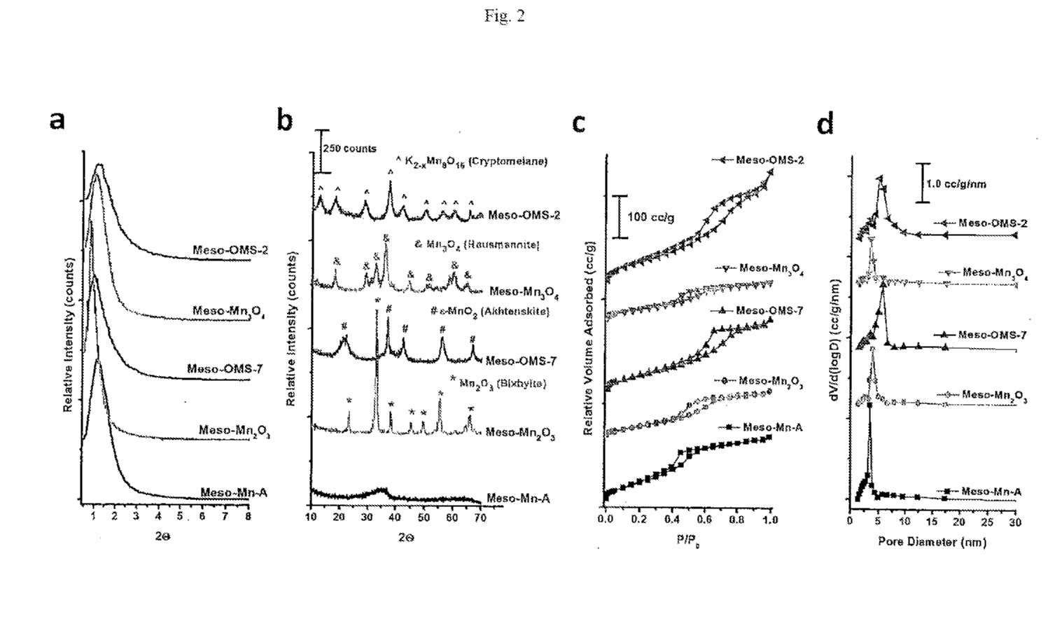

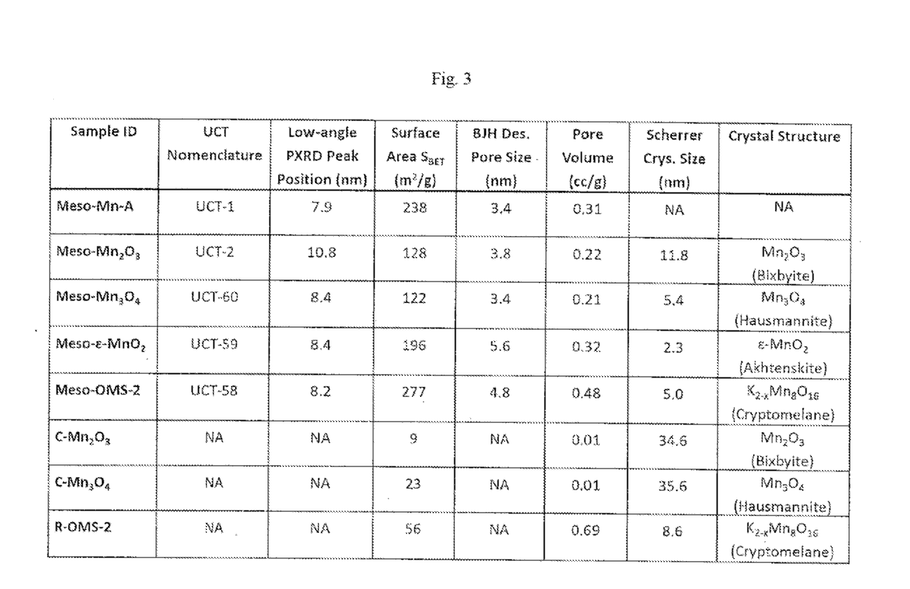

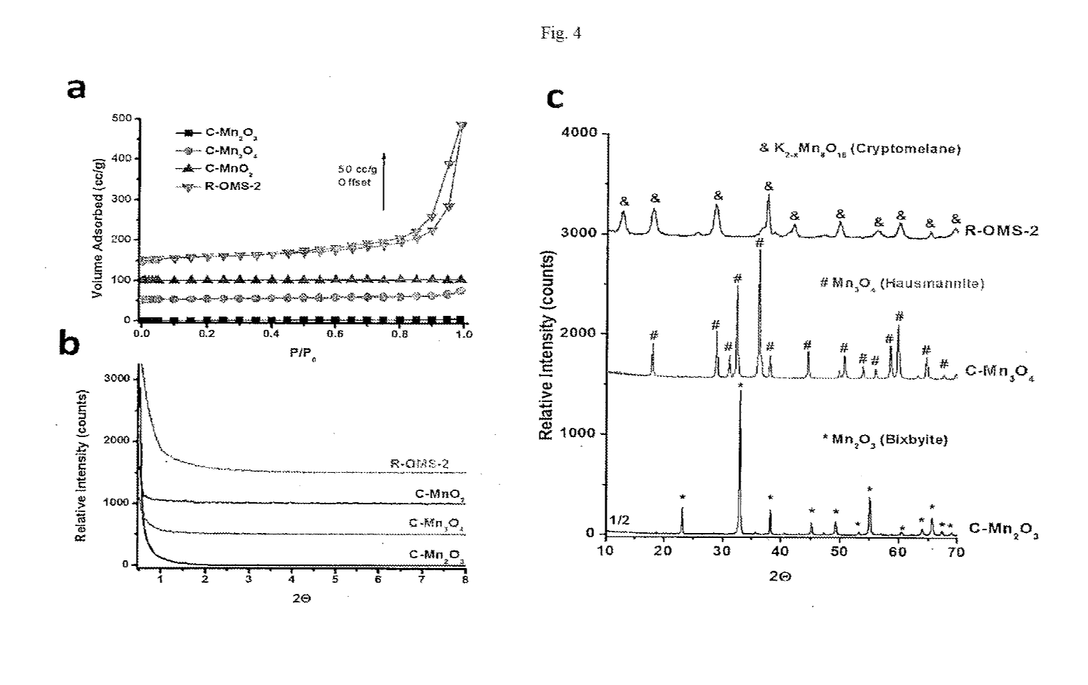

FIG. 2 shows the physicochemical characterization results of synthesized mesoporous manganese oxide samples. All samples, regardless of crystal structure, preserve the meso structure as demonstrated by a one low-angle diffraction line (FIG. 2a). The position of the diffraction lines range between 7.9-10.8 nm with Meso-Mn₂O₃ is being the highest (10.8 nm) (FIG. 3). The position of the low angle diffraction line indicates the size of building blocks (nanoparticles). Upon the transformations, the materials demonstrate broad wide-angle diffractions lines suggesting a nanocrystalline nature. The calculated Scherrer crystallite sizes are given in FIG. 3. For comparison, commercial Mn₂O₃ (C—Mn₂O₃), commercial Mn₃O₄ (C—Mn₃O₄), and non-porous OMS-2 (R-OMS-2) were also analyzed. Their structural properties are also summarized in FIG. 3 and data were shown in FIG. 4. Unlike mesoporous materials, the non-porous C—Mn₂O₃, C—Mn₃O₄, and R-OMS-2 do not have a low-angle diffraction and have very sharp wide-angle diffraction lines suggesting well crystalline structure (FIGS. 4b and 4c).

N₂ sorption isotherms of mesoporous manganese oxide samples can be labeled to a Type-IV isotherm indicating existence of a mesoporous structure followed by a Type-I hysteresis loop suggesting a regular-cylindrical porous structure (FIG. 2c). On the other hand, non-porous manganese oxide counterparts show a Type V isotherm indicates non-porous nature of these samples (FIG. 4a). BJH desorption pore size distributions of mesoporous manganese oxide samples are shown in FIG. 2d. All mesoporous samples have sharp mesopore size distributions. The BET surface areas, BJH desorption pore diameters and mesopore volumes of mesoporous and non-porous manganese oxide samples are all summarized in FIG. 3. All mesoporous samples have significantly higher surface areas (as high as 277 m²/g) and pore volumes (as high as 0.48 cc/g).

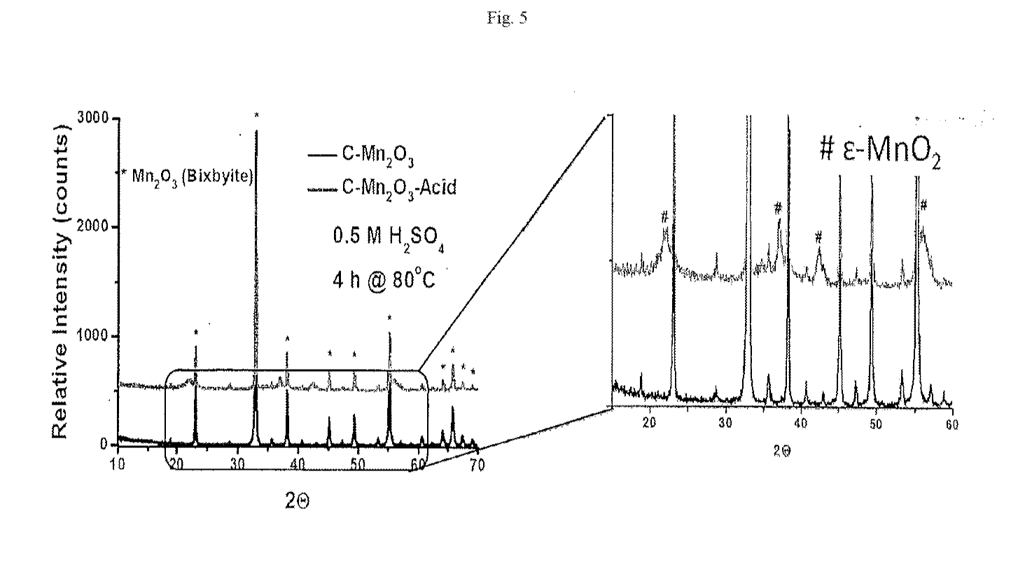

In order to confirm the mildness of the transformation conditions, a control experiment was also conducted using C—Mn₂O₃. The transformation was done using 0.3 g of C—Mn₂O₃ instead of MesoMn-A and the reaction time was 4 hours instead of 2 hours. The transformation was incomplete and only a small fraction of the C—Mn₂O₃ was transformed to e-MnO₂ phase (FIG. 5). Most probably, the transformation only occurred on the surface of the powder and the inside remained the same. Due to high porosity and intraconnected porosity of the mesoporous manganese oxide samples, the same conditions can successfully complete the transformation.

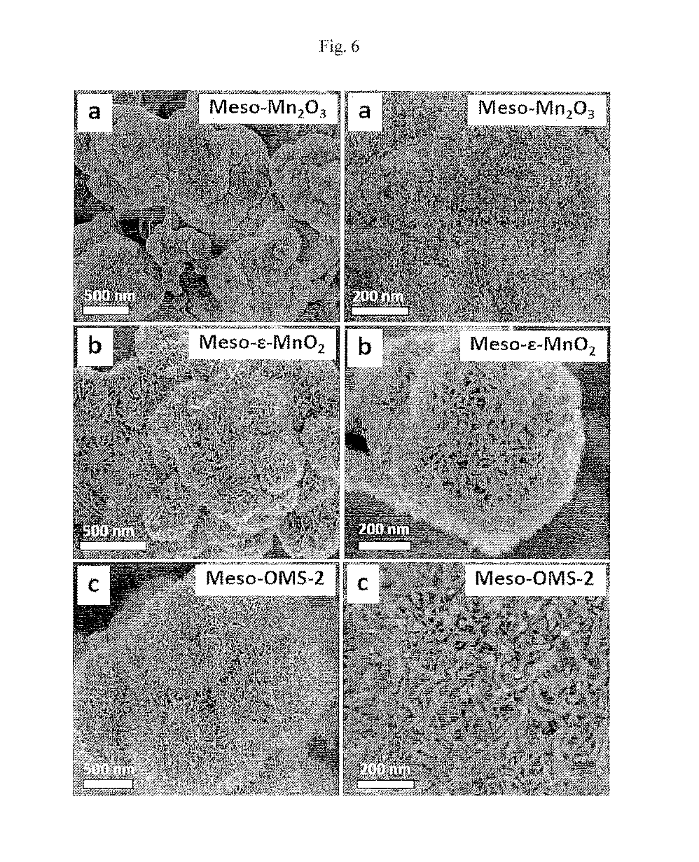

Morphology studies of the mesoporous samples were conducted using SEM (FIG. 6). The acid treatment caused drastic changes on the surface morphology of mesoporous manganese oxides, despite the low magnification images showing aggregated micron sized spheres for all samples. Direct heat treatment of Meso-Mn-A to form Meso-Mn₂O₃ did not cause a significant change in the surface morphology. The sample preserved its relatively smooth surface morphology. However, the surface morphology of Meso-ε-MnO₂ particles show flakes growing out the particles with wide openings (FIG. 6b) and Meso-OMS-2 sample has surfaces covered by needles growing out the spherical particles (FIG. 6c).

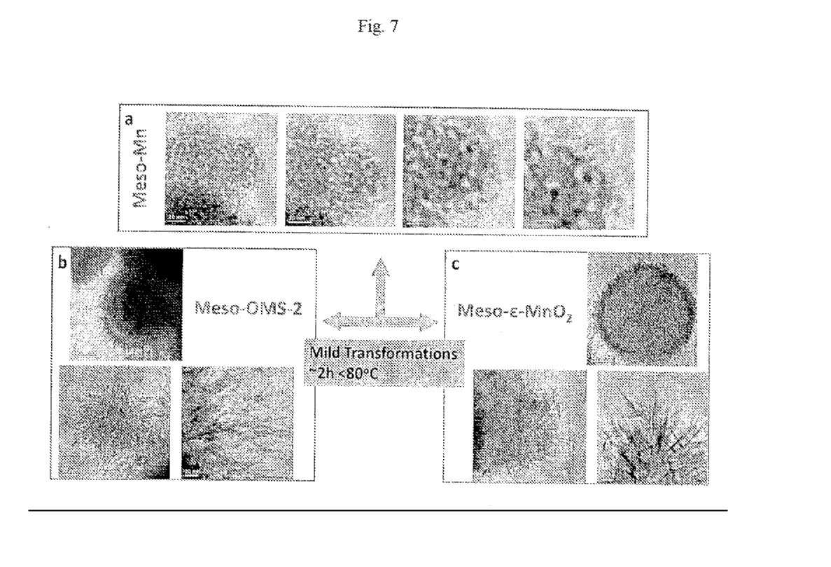

HR-TEM images of mesoporous manganese oxide samples were also collected for better evaluation of the changes of surface morphologies (FIG. 7). HR-TEM images of MesoMn-A and Meso-Mn₂O₃ samples show nano-particle aggregates with a porous nature formed by intraparticle voids (mesopores) (FIG. 7a). Unlike Meso-Mn₂O₃ sample, the origin of mesoporosity is not clear for Meso-ε-MnO₂ and Meso-OMS-2 samples due to the sample thickness. HR-TEM images of Meso-ε-MnO₂ (FIG. 7c) and Meso-OMS-2 (FIG. 7b) show flakes and needles growing on the surface of particles which is consistent with the SEM analyses.

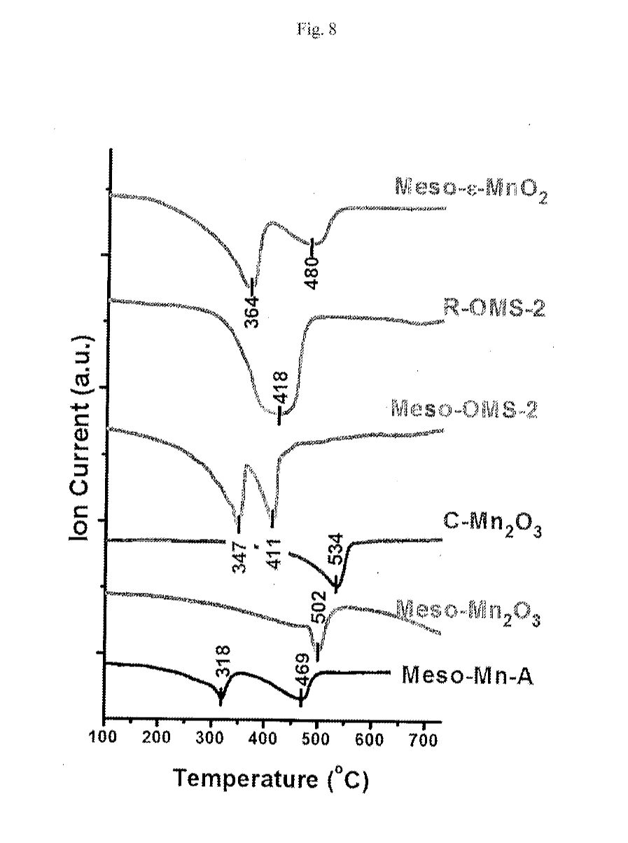

The redox properties of mesoporous manganese oxides were examined by temperature programmed reduction (H₂-TPR) studies and compared with the non-porous manganese oxides (FIG. 8). Manganese oxides are known to be very active catalysts in both selective and total oxidation of organic compounds in both liquid and gas phase reactions. Their catalytic performances are also known to be well correlated with their redox properties. Meso-Mn-A showed the lowest reduction temperature of 318° C. with a two-step reduction (the second is at 469° C.). Meso-Mn₂O₃ was reduced in one step with a peak position of 502° C. which was lower than the commercial analogue (C-Mn₂O₃, 534° C.). The shift of the reduction temperature was attributed to the more easily reducible nature of nano-crystalline Meso-Mn₂O₃. Meso-OMS-2 showed a two-step reduction (at 347° C. and 411° C.) and the ratio of the lower temperature peak to the higher temperature peak was around 1. Therefore, the lower temperature reduction was attributed to the reduction of MnO₂ to Mn₂O₃ and the higher temperature peak was attributed to the reduction of Mn₂O₃ to MnO.

On the other hand, ROMS-2 (non-porous) only showed one broad reduction peak centered at 418° C., which is typical for large and non-porous particles. Meso-ε-MnO₂ also showed a two-step reduction (at 364° C. and 480° C.) and the ratio of the lower temperature peak to the higher temperature peak was around 2. The lower temperature reduction was attributed to the reduction of MnO₂ to Mn₃O₄ and the higher temperature peak was attributed to the reduction of Mn₃O₄ to MnO. H₂-TPR studies also confirm the nano-particle nature of mesoporous manganese oxides and their clearly different redox properties of non-porous manganese oxides.

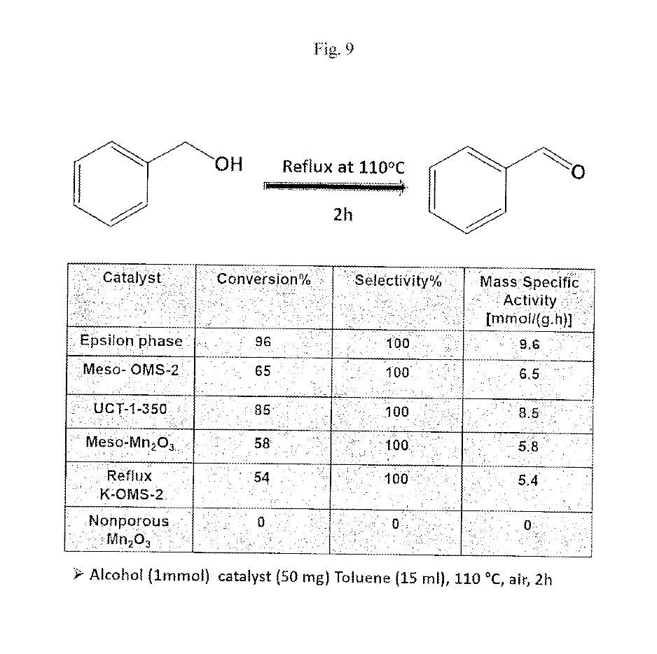

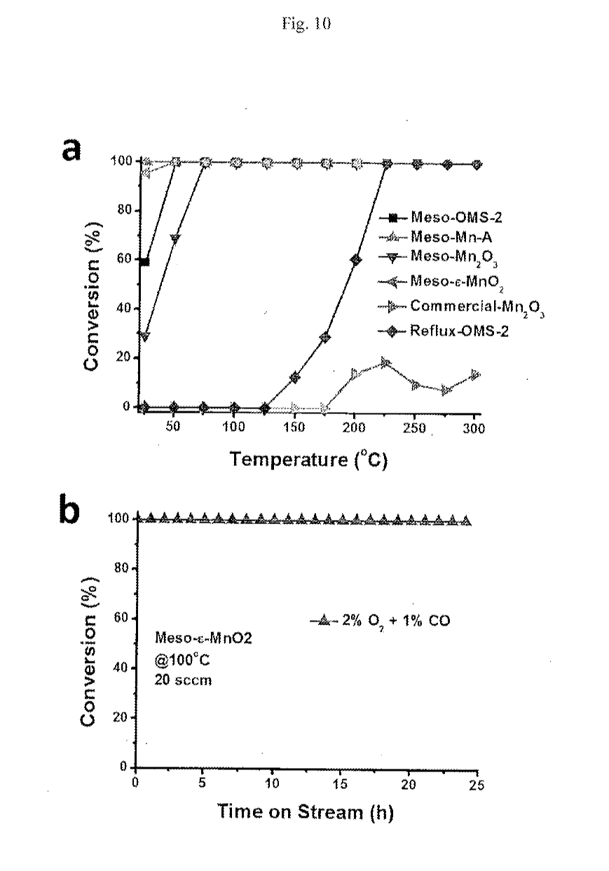

The catalytic performances of mesoporous manganese oxides were tested for selective oxidation of benzyl alcohol (to benzaldehyde) (FIG. 9) and total gas phase oxidation of CO (to CO₂) (FIG. 10). For both reactions mesoporous manganese oxides were significantly more active compared to non-porous manganese oxides. The highest catalytic activity for selective oxidation of benzyl alcohol to benzaldehyde was observed with ε-MnO₂ sample. The catalyst gives a conversion of 96% with excellent selectivity (100%).

The catalytic activity of mesoporous manganese oxides was tested for CO oxidation FIG. 10a. Meso-Mn-A showed the highest activity (100% conversion at RT). Meso-ε-MnO₂ and Meso-OMS-2 demonstrated similar activity and both reached 100% conversions at 50° C. However, Meso-ε-MnO₂ was slightly more active than Meso-OMS-2, which showed 95% (vs. 60%) conversion at RT. Meso-Mn₂O₃ showed the lowest activity among the mesoporous manganese oxides and 100% conversion was observed at 75° C. All mesoporous manganese oxides were much more active than low porosity manganese oxides (R-OMS-2 & C—Mn₂O₃). R-OMS-2 reached 100% conversion at 225° C. and C—Mn₂O₃ only reached 20% conversion at the same temperature. The ε-MnO₂ phase (Meso-ε-MnO₂) was found to be the most active phase among the crystalline samples. Therefore, Meso-ε-MnO₂ was also used for the catalytic stability tests (FIG. 10b) and no activity loss was observed for CO oxidation after 24 hours of reaction.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims. Also, the subject matter of the appended dependent claims is within the full intended scope of all appended independent claims.

What is claimed is:

1. A process for preparing a crystalline mesoporous metal oxide, said process comprising:
providing an acidic mixture comprising an amorphous mesoporous metal oxide; and
heating the acidic mixture at a temperature and for a period of time sufficient to form the crystalline mesoporous metal oxide.

2. The process of claim 1, wherein the acidic mixture is heated at a temperature less than about 80° C. for a period less than about 2 hours.

3. The process of claim 1, wherein the acidic mixture comprises an aqueous acidic solution less than or equal to 0.5 M H⁺ or less than or equal to 0.5 M K⁺.

4. The process of claim 1, wherein the acidic mixture is heated at a temperature less than about 70° C. for a period less than about 1.5 hours.

5. The process of claim 1, wherein the acidic mixture comprises an aqueous acidic solution less than or equal to 0.4 M H⁺ or less than or equal to 0.4 M K⁺.

6. The process of claim 1, wherein the amorphous mesoporous metal oxide is selected from the group consisting of an amorphous mesoporous transition metal oxide, an amorphous mesoporous Lanthanide metal oxide, an amorphous mesoporous post-transition metal oxide, an amorphous mesoporous metalloid oxide, and mixtures thereof.

7. The process of claim 6, wherein the transition metal comprises a Group 3-12 transition metal selected from the group consisting of a Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and Hg.

8. The process of claim 6, wherein the Lanthanide metal is selected from the group consisting of a La, Ce, Pr, Nd, Pm, Sm, Eu, Gd, Tb, Dy, Ho, Er, Tm, Yb and Lu.

9. The process of claim 7, wherein the post-transition metal is selected from the group consisting of an Al, Ga, In, Tl, Sn, Pb and Bi.

10. The process of claim 7, wherein the metalloid is selected from the group consisting of a B, Si, Ge, As, Sb, Te, Po and At.

11. The process of claim 1, wherein the crystalline mesoporous metal oxide has a pore size (diameter) between about 1.5 nanometers and about 50 nanometers.

12. The process of claim 1, which is conducted under process conditions sufficient to control pore size and pore size distribution of the crystalline mesoporous metal oxide and crystal structure of nano-sized metal oxide walls.

13. The process of claim 1, wherein the crystalline mesoporous metal oxide is selected from the group consisting of a crystalline mesoporous transition metal oxide, a crystalline mesoporous Lanthanide metal oxide, a crystalline mesoporous post-transition metal oxide, a crystalline mesoporous metalloid oxide, and mixtures thereof.

14. The process of claim 13, wherein the transition metal comprises a Group 3-12 transition metal selected from the group consisting of a Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and Hg.

15. The process of claim 13, wherein the Lanthanide metal is selected from the group consisting of a La, Ce, Pr, Nd, Pm, Sm, Eu, Gd, Tb, Dy, Ho, Er, Tm, Yb and Lu.

16. The process of claim 13, wherein the post-transition metal is selected from the group consisting of an Al, Ga, In, Tl, Sn, Pb and Bi.

17. The process of claim 22, wherein the metalloid is selected from the group consisting of a B, Si, Ge, As, Sb, Te, Po and At.

18. A crystalline mesoporous metal oxide produced by a process comprising:
providing an acidic mixture comprising an amorphous mesoporous metal oxide; and
heating the acidic mixture at a temperature and for a period of time sufficient to form the crystalline mesoporous metal oxide.

19. The crystalline mesoporous metal oxide of claim 19, wherein the acidic mixture is heated at a temperature less than about 80° C. for a period less than about 2 hours.

20. The crystalline mesoporous metal oxide of claim 19, wherein the acidic mixture comprises an aqueous acidic solution less than or equal to 0.5 M H⁺ or less than or equal to 0.5 M K⁺.

21. The crystalline mesoporous metal oxide of claim 19, wherein the acidic mixture is heated at a temperature less than about 70° C. for a period less than about 1.5 hours.

22. The crystalline mesoporous metal oxide of claim 19, wherein the acidic mixture comprises an aqueous acidic solution less than or equal to 0.4 M H⁺ or less than or equal to 0.4 M K⁺.

23. A method of controlling nano-sized wall crystallinity and mesoporosity in mesoporous metal oxides, said method comprising:
providing an acidic mixture comprising an amorphous mesoporous metal oxide; and
heating the acidic mixture at a temperature and for a period of time sufficient to control nano-sized wall crystallinity and mesoporosity in the mesoporous metal oxides.

24. The method of claim 23, wherein the acidic mixture is heated at a temperature less than about 80° C. for a period less than about 2 hours.

25. The method of claim 23, wherein the acidic mixture comprises an aqueous acidic solution less than or equal to 0.5 M H⁺ or less than or equal to 0.5 M K⁺.

26. The method of claim 23, wherein the acidic mixture is heated at a temperature less than about 70° C. for a period less than about 1.5 hours.

27. The method of claim 23, wherein the acidic mixture comprises an aqueous acidic solution less than or equal to 0.4 M H⁺ or less than or equal to 0.4 M K⁺.

28. A crystalline mesoporous metal oxide particulate having nano-sized wall crystallinity, a particle size between about 1 and about 500 nm, a BET surface area between about 50 and about 1000 m²/g, a pore volume (BJH) between about 0.05 and about 2 cm³/g, a monomodal pore size (BJH desorption) distribution between about 1 and 25 nm, and optionally a wall thickness (2 d/√3−PD, where d is the d-spacing and PD is the pore diameter) between about 2 and about 20 nm; wherein the mesoporous metal oxide particulate exhibits thermal stability up to a temperature of about 550° C.

29. The mesoporous metal oxide particulate of claim 28 having a particle size between about 50 and about 300 nm, a BET surface area between about 60 and about 500 m²/g, a pore volume (BJH) between about 0.075 and about 2 cm³/g, a monomodal pore size (BJH desorption) distribution between about 2 and 13 nm, and optionally a wall thickness (2 d/√3−PD, where d is the d-spacing and PD is the pore diameter) between about 4 and about 14 nm.

30. A method of tuning structural properties of mesoporous metal oxides, said method comprising:
providing an acidic mixture comprising an amorphous mesoporous metal oxide; and
heating the acidic mixture at a temperature and for a period of time sufficient to tune the structural properties of the mesoporous metal oxides.

31. The method of claim 30, wherein the acidic mixture is heated at a temperature less than about 80° C. for a period less than about 2 hours.

32. The method of claim 30, wherein the acidic mixture comprises an aqueous acidic solution less than or equal to 0.5 M H⁺ or less than or equal to 0.5 M K⁺.

33. The method of claim 30, wherein the acidic mixture is heated at a temperature less than about 70° C. for a period less than about 1.5 hours.

34. The method of claim 30, wherein the acidic mixture comprises an aqueous acidic solution less than or equal to 0.4 M H⁺ or less than or equal to 0.4 M K⁺.
